(19) United States
(12) Patent Application Publication
(10) Pub. No.: US 2016/0096604 A1
(43) Pub. Date: Apr. 7, 2016

(54) MICRO-SCALE VEHICLE HAVING A PROPULSION DEVICE

(71) Applicant: Brigham Young University, Provo, UT (US)

(72) Inventors: Brian D. IVERSON, Provo, UT (US); Jonathan C. CLAUSSEN, Ames, IA (US)

(21) Appl. No.: 14/877,594

(22) Filed: Oct. 7, 2015

Related U.S. Application Data
(60) Provisional application No. 62/071,974, filed on Oct. 7, 2014.
(60) Provisional application No. 62/081,330, filed on Nov. 18, 2014.

(51) Int. Cl. B63H 11/16; F02K 7/08

(52) U.S. Cl. CPC B63H 11/16; F02K 7/08; Y10S 977/902; B82Y 99/00

(57) ABSTRACT

In one general aspect, an apparatus can include a controller and a fuel container. The apparatus can include a propulsion device including a carbon nanotube structure including a parallel array of micro-channels configured to receive the fuel. Each of the micro-channels included in the array of micro-channels can have a length:width aspect ratio greater than 40:1 and can include a catalyst.

### RELATED APPLICATIONS

This application claims priority to and the benefit of U.S. Provisional Patent Application No. 62/071,974, filed Oct. 7, 2014 and U.S. Provisional Patent Application No. 62/081,330, filed Nov. 18, 2014, both of which are incorporated herein by reference in their entireties.

### STATEMENT REGARDING FEDERALLY SPONSORED RESEARCH

This application was made with government support under Navy Contract No. N00173-11-1-G002. The government has certain rights in this application.

### TECHNICAL FIELD

This description relates to a micro-scale vehicle having a propulsion device.

### BACKGROUND

Various techniques have been used to create micro-scale vehicles and propulsion devices thereof. However many of these micro-scale vehicles do not have the capability to maneuver in a desirable fashion because of the types of propulsion devices that have been developed and used in these vehicles. Thus, a need exists for systems, methods, and apparatus to address the shortfalls of present technology and to provide other new and innovative features.

### SUMMARY

In one general aspect, an apparatus can include a controller and a fuel container. The apparatus can include a propulsion device including a carbon nanotube structure including a parallel array of micro-channels configured to receive the fuel. Each of the micro-channels included in the array of micro-channels can achieve a length:width aspect ratio greater than 40:1 and can include a catalyst.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example of a vehicle, according to an implementation.

FIG. 2 is a diagram that illustrates another example of a vehicle, according to an implementation.

FIGS. 3A through 3G illustrate aspects of a propulsion device microfabrication process.

FIGS. 4A through 4D are images illustrate resultant nanoparticle morphology and density within multi-walled carbon nanotube microarray membranes (CNT-MMs).

FIGS. 5A through 5D are images used to confirm the deposition of nanoparticles onto CNTs

FIG. 6A through 6C illustrate images of water droplets on a CNT-MM at various stages of fabrication.

FIGS. 6D and 6E are graphs associated with FIGS. 6A through 6C.

FIGS. 7A through 7E illustrate effective activation energy data for CNT-MM propulsion devices.

FIGS. 8A through 8C illustrate aspects of a micro underwater vehicle (MUV) submersible.

FIGS. 9A and 9B illustrate thrust measurement plots for H₂O₂ decomposition-driven propulsion.

FIG. 10 is a diagram that illustrates operation of a propulsion device.

### DETAILED DESCRIPTION

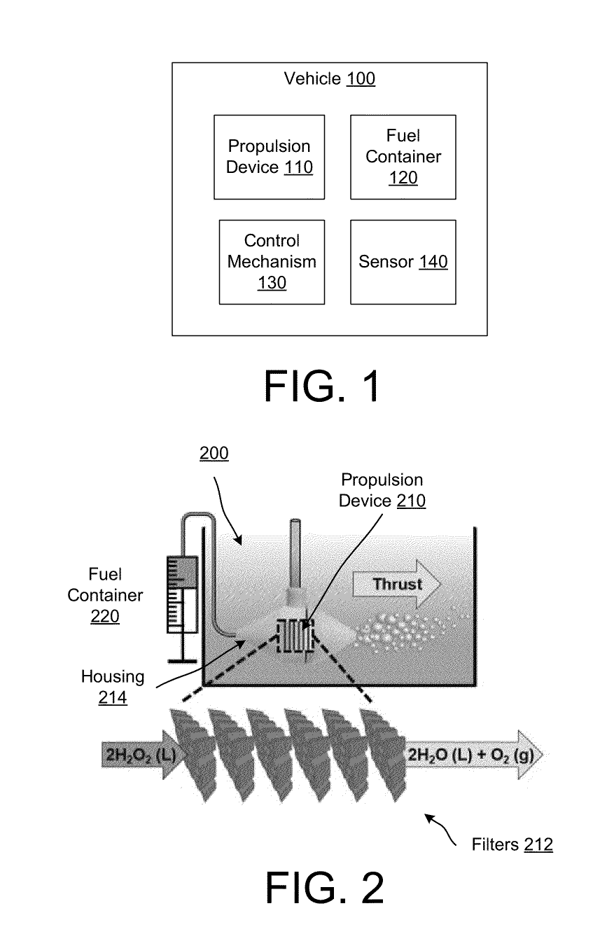

FIG. 1 is a diagram that illustrates an example of a vehicle 100, according to an implementation. In this implementation, the vehicle 100 includes a propulsion device 110, a fuel container 120, a controller 130, and a sensor 140. In some implementations, the vehicle 100 can include other elements, or can exclude one or more of the elements noted above. In some implementations, the vehicle 100 can be configured to operate within a fluid (e.g., water). In some implementations, the vehicle can be referred to as a Micro Underwater Vehicle (MUV) (e.g., an unmanned underwater vehicles (UUVs) between approximately 1-50 cm in length). In some implementations, one or more portions of the vehicle 100 can be included in a housing (not shown).

In some implementations, the propulsion device 110 can function as a propulsion device for the vehicle 100. In some implementations, the propulsion device 110 can be configured to provide propulsion in one or more directions. In some implementations, the propulsion device 110 can be used for positioning and or thrust. In some implementations, the propulsion device 110 can provide propulsion in addition to other propulsion devices such as a propeller. In some implementations, the propulsion device 110 can be used in conjunction with one or more steering mechanisms.

In some implementations, the propulsion device 110 can include, or can be, a carbon nanotube (CNT) structure. In some implementations, the propulsion device 110, or a portion thereof, can be referred to as a microfilter. In some implementations, the propulsion device 110 can be a CNT structure that includes, or can be, a multi-walled carbon nanotube microarray membrane (CNT-MM). In some implementations, the propulsion device 110 can include a two-dimensional array of micro-channels (which can be lumens therethrough). The micro-channels can be aligned in parallel with one another within the propulsion device 110. A direction of thrust or propulsion from the micro-channels can be aligned along a lumen defined by the micro-channels.

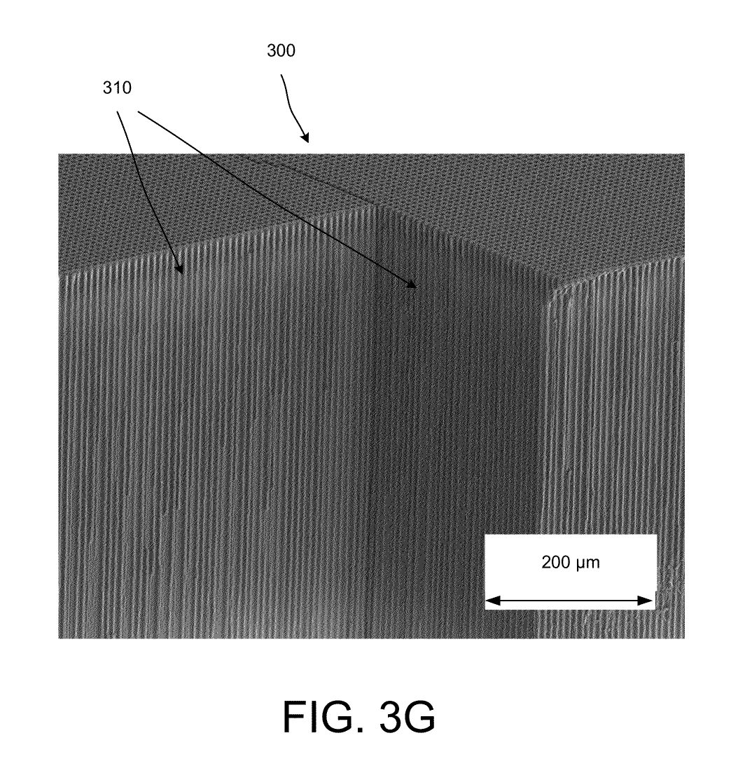

In some implementations, one or more of the micro-channels of a CNT structure included in the propulsion device 110 can have a length (or micro-channel):width (across the lumen defined by the micro-channel) aspect ratio greater than 10:1 (e.g., 40:1, 50:1, 100:1, 200:1). In some implementations, one or more micro-channels of the propulsion device 110 can have a different aspect ratio. For example, a first micro-channel of the propulsion device 110 can have a first aspect ratio and a second micro-channel the propulsion device 110 can have a second aspect ratio. As another example, a first micro-channel of a first CNT structure of the propulsion device 110 can have a first aspect ratio and a second micro-channel of a second CNT structure of the propulsion device 110 can have a second aspect ratio. An example of a CNT structure 300 with a high aspect ratio is illustrated in at least FIG. 3G.

In some implementations, the propulsion device 110 can include multiple CNT structures that are aligned (e.g., stacked) in series or aligned laterally. In a series configuration, a microchannel (e.g., a lumen of the microchannel) associated with a first CNT structure can be aligned along the same line (or substantially along the same line) as a microchannel associated with a second CNT structure. In other words, microchannel associated with the first CNT structure can be axially aligned with microchannel of the second CNT structure. Said differently, the CNT structures may be stacked along a direction that is aligned with a propulsion direction. In a lateral configuration, a microchannel associated with a first CNT structure can be aligned parallel to (and lateral to) a microchannel associated with a second CNT structure. In some implementations, a lateral configuration can be referred to as a vertical configuration because the CNT structures may be vertically stacked one above the other, which is orthogonal to a horizontal propulsion direction. In other words, the CNT structures may be stacked along a direction that is orthogonal to a propulsion direction. In some implementations, the propulsion device 110 can include multiple CNT structures that are aligned nonparallel to one another such that a first CNT structure has a microchannel aligned in a first direction and a second CNT structure is aligned in a second direction nonparallel to (e.g., orthogonal to) the first direction.

As shown in FIG. 1, the vehicle 100 includes a fuel container 120. In some implementations, the fuel container 120 can include one or more fuels that can be provided to the propulsion device 110. The one or more fuels of the vehicle 100 can be used by (e.g., reacted within) the propulsion device 110 to produce thrust and propel the vehicle 100 in one or more directions. In some implementations, the fuel container 120 can be configured to contain a fuel such as hydrogen peroxide H₂O₂, methanol, and hydrocarbons and/or so forth. In some implementations, the fuel, when reacted can result in an expansion (e.g., expansion as a gas product (e.g., steam)), which results in a thrust. In some implementations, the fuel container 120 can be excluded from the vehicle 100 because fuel can be obtained from an environment around the vehicle 100.

As shown in FIG. 1, the vehicle 100 includes a control mechanism 130. In some implementations, the control mechanism 130 can be configured to control a direction of movement of the vehicle 100. For example, the control mechanism 130 can include one or more fins, thrust vanes, nozzles, and/or so forth that can be used to control the direction of the vehicle 100 as thrust is being provided by the propulsion device 110.

In some implementations, the control mechanism 130 can include a processor such as a microcontroller. In some implementations, the control mechanism 130 can include one or more wireless devices configured to transmit and/or send wireless communications. In some implementations, the control mechanism 130 can include an electronic storage component such as a memory.

Although not shown in FIG. 1, in some implementations, the vehicle 100 can include one or more energy acquisition components and/or energy storage components. For example, the vehicle 100 can include a solar cell. As another example, the vehicle 100 can include a battery.

As shown in FIG. 1, the vehicle 100 includes a sensor 140 (e.g., a sensor payload). In some implementations, the sensor 140 can be, or can include one or more image capture devices, thermal detection devices, and/or so forth.

In some implementations, the vehicle 100 can include a variety of payloads. For example, the vehicle 100 can include a payload for delivery to a location.

In some implementations, the utility of the vehicle 100, which can be an unmanned MUV, can be important for exploring confined spaces. In some implementations, the vehicle 100 can have a desirable spatial agility when maneuvers require, for example, burst-propulsion.

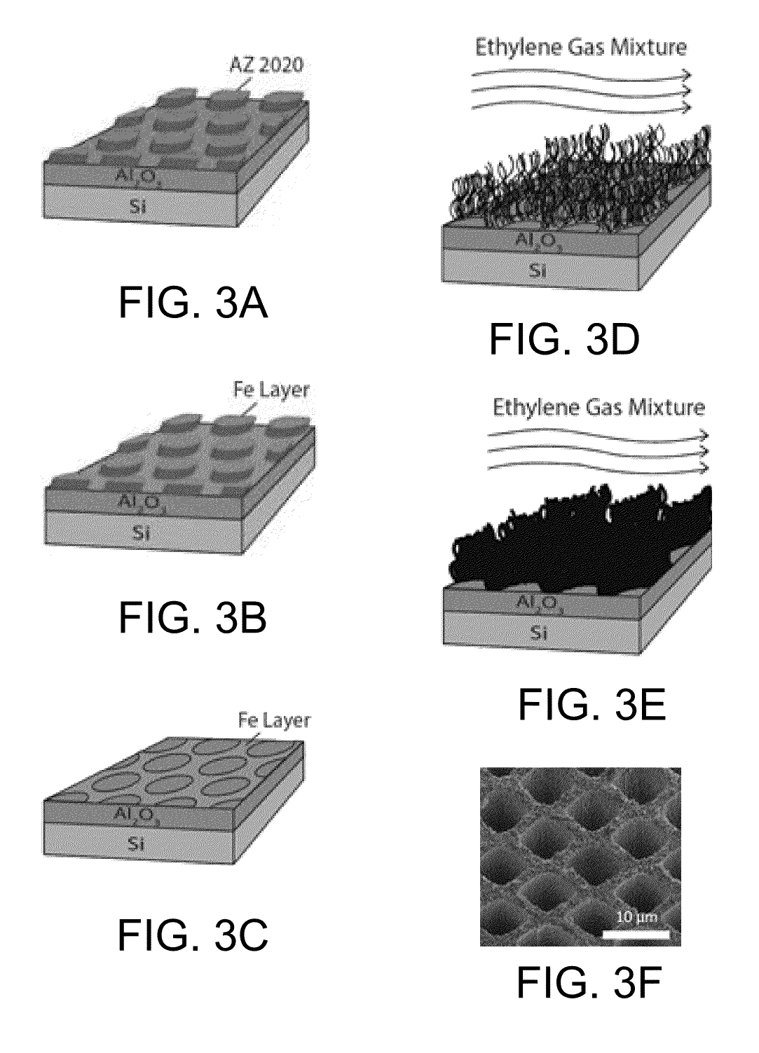

FIG. 2 is a diagram that illustrates an example of a vehicle 200, according to an implementation. The vehicle 200 can be an implementation of the vehicle 100 shown in FIG. 1. In this implementation, the vehicle 200 is disposed in a fluid and configured to provide thrust within the fluid.

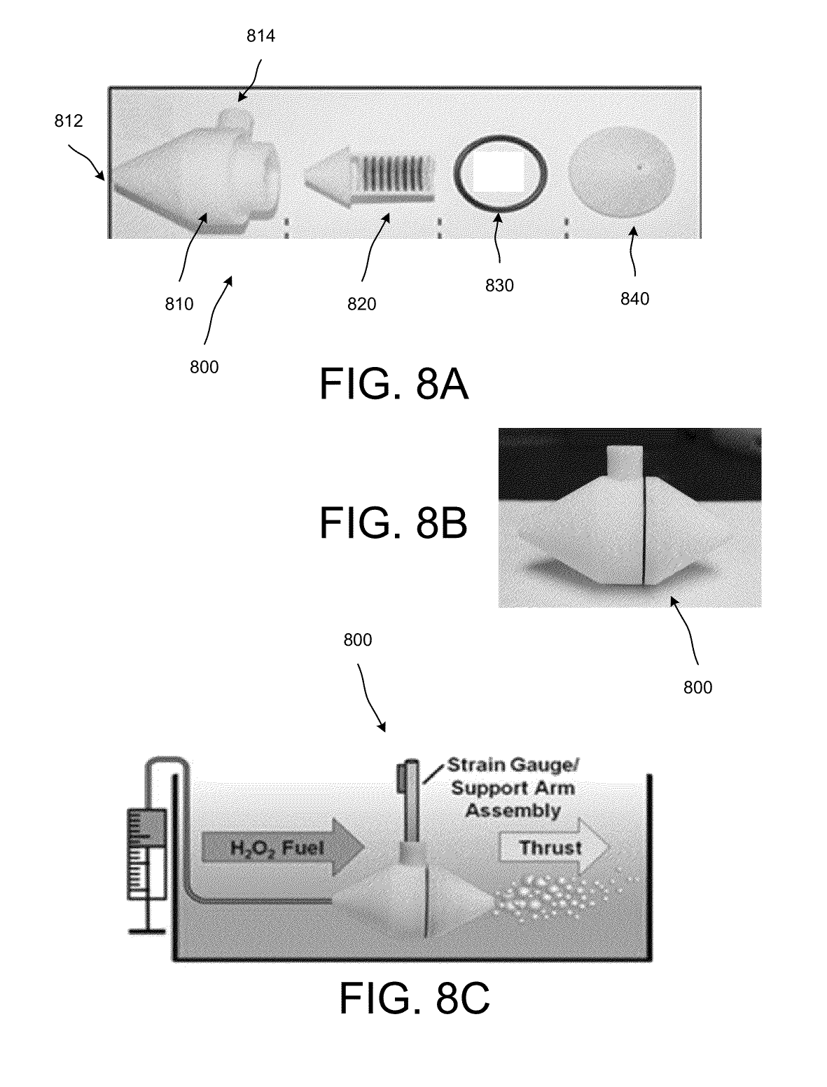

In this implementation, the vehicle 200 includes a propulsion device 210 and a fuel container 220. The propulsion device 210 is included in a housing 214. Although illustrated in this implementation as being outside of the housing 214, in some implementations, the fuel container 220 can also be included within the housing 214. As shown in FIG. 2, the propulsion device 210 includes several CNT structures 212 that are aligned in series. More details related to the example implementation shown in FIG. 2 are shown and described in connection with at least FIGS. 8A through 8C.

Referring back to FIG. 1, in some implementations, the vehicle 100 can include a high-aspect ratio (150:1), multi-walled carbon nanotube microarray membranes (CNT-MMs) for propulsive, MUV thrust generation by the decomposition of a fuel (e.g., hydrogen peroxide (H₂O₂)). In some implementations, the CNT-MMs can be grown via chemical vapor deposition with pores of a variety of shapes (e.g., diamond shaped pores (nominal diagonal dimensions of, for example, 4.5×9.0 μm)). In some implementations, large surface area and desirable geometry (corners, edges, etc.) catalytic nanoparticles can be coupled to one or more of the pores. In some implementations, an urchin-like, catalytic nanoparticles (e.g., platinum (Pt) nanoparticles, palladium (Pd) nanoparticles, gold (Au) nanoparticles, silver (Ag) nanoparticles, and/or so forth) can be coupled to one or more of the pores via a facile, electroless, chemical deposition process. Accordingly, an CNT-MM including a Pt nanoparticles, for example, can be referred to as a Pt-CNT-MM. The urchin-like shape can include an inner mass (e.g., a sphere-shaped mass or another shaped mass) with spindles or protrusion extending therefrom. In some implementations, a CAT-CNT-MM (where CAT represents a catalytic material) can a have a robust, high catalytic ability with a desirable effective activation energy (e.g., an activation energy of 26.96 kJ mol⁻¹) capable of producing a thrust (e.g., a thrust of 0.209±0.049 N) from decomposition of a fuel (e.g., 50% w/w (or different) H₂O₂ decomposition) within a compact reaction chamber (e.g., a reaction chamber of eight Pt-CNT-MMs in series).

In some implementations, the vehicle 100 can be configured for exploration of confined spaces such as shipwrecks, submerged oil pipelines, and various military purposes. In some implementations, the vehicle 100 can be configured to perform tight radius turns, burst-driven docking maneuvers, and low-speed course corrections, in contrast to some propeller-based systems that can be limited in such abilities and can be often used for long-endurance missions. These relatively complex motions often require energy-dense fuels, which can be quickly and efficiently utilized to provide sudden bursts of propulsion. Such energy-dense fuels/reagents include hydrogen peroxide (H₂O₂), methanol, hydrocarbons, and/or so forth and can be contained in the fuel container 120.

As a specific example, the decomposition of H₂O₂ as a fuel in the fuel container 120 used for locomotion in micro-scale applications can be of particular interest because of its scalability, as well as possessing a relatively large power density (up to 45 times that of Ni—Cd batteries in MUVs). In addition, H₂O₂ can be an environmentally friendly fuel, expending only green by-products (i.e., oxygen, O₂, and water) during decomposition. In some implementations, when exposed to a metal catalyst such as platinum (Pt), H₂O₂ can be broken down in an exothermic reaction into O₂ (and water) which provides thrust through the significant volumetric change relative to the liquid fuel within the propulsion device 110.

The propulsion device 110 of the vehicle 100 can have a structure that relies on transport-enhancing mechanisms to decompose a fuel such as a H₂O₂ fuel. The propulsion device 110 can have a catalytic structure that employs transport-enhancement, but that can be fabricated for burst-propulsion of MUVs and their associated payloads. Thrust required for these applications is provided by the fabrication of scalable catalytic structures which offer the high surface area to fuel volume ratios required for burst-propulsion, while maintaining a small volumetric profile.

Carbon nanotube (CNT)-templated microfabrication, which can be included in the propulsion device 110, is a new approach to constructing high aspect ratio structures that capitalizes on the very large length to diameter ratios present for carbon nanotubes. For modest growth lengths of, for example, 1 mm and a nominal spacing of, for example, 100 nm between carbon nanotubes, aspect ratios of, for example, 10-10,000 are achievable for vertically aligned growth. When combined with lithographically defined growth, almost any aspect ratio in this range can be realized. This range is significantly better than typical etching techniques for high aspect ratio structures such as Deep Reactive Ion Etching (DRIE) and offers distinct advantages over Lithography, Electroplating, and Molding (LIGA) in cost, time, and scalability. Using patterned CNTs as a scaffold, additional materials can be coated on or infiltrated into the forest, making these structures rigid and reinforced. The conditions and duration of an infiltration procedure can be controlled to result in highly dense or highly porous regions. Therefore two-tier, porous materials can be constructed with CNT-templated microfabrication; larger (micron-scale) spacings controlled by lithography and smaller (nanometer-scale) spacings controlled by carbon nanotube forest density and subsequent infiltration. Multi-walled carbon nanotube microarray membranes (CNT-MMs) fabricated by this method thereby provide a versatile microstructure for reagent-based burst-propulsion. Thus, this distinct CNT-templated microfabrication process enables the growth of aligned, high aspect ratio CNT micro-channel membranes—a three-dimensional microstructure that cannot be formed from conventional, stand-alone CNT fabrication techniques such as screen-printing, electrospraying, alcohol catalytic chemical vapor deposition, plasma-enhanced chemical vapor deposition, self-assembled monolayer linking, and thermal crosslinking.

CNT-MM structures, which can be included in the propulsion device 110, can be functionalized using electroless deposition of a catalyst such as Pt onto CNTs to provide highly catalytic microstructures for burst-propulsion applications. For example, deposition by the reduction of chloroplatinic acid can be one-step process offering several advantages. Most notably is that the morphology and density of, for example, Pt nanoparticles on carbon structures is controllable. Similar depositions can be performed on highly ordered 3D graphene. This technique can provide effective electrocatalytic functionalization for scalable substructures. Furthermore, Pt deposited in this fashion on nanocellulose is highly durable during MUV propulsion tests using, for example, 30% w/w H₂O₂. Based on this, electroless deposition of Pt nanoparticles by the reduction of chloroplatinic acid can provide a controllable, scalable, and mechanically robust catalytic structure for the aggressive decomposition of H₂O₂ fuel at relatively high concentrations (e.g., 50% w/w).

Following deposition, CAT-CNT-MMs, which can be included in the propulsion device 110, can be inspected and characterized using both scanning electron microscopy (SEM) and transmission electron microscopy (TEM). In some implementations, for example, Pt-CNT-MMs can have continuous coverage of Pt on the CNT micro-channels. These catalytic structures can have hydrophobicity (from water contact angle analysis), electroactive specific surface area (from cyclic voltammetry (CV) experiments), surface area calculated (from Brunauer-Emmett-Teller (BET) analysis on nitrogen adsorption experiments), as well as effective activation energy (from H₂O₂ decomposition profiles).

As noted above, an example of the vehicle 100 can have an average thrust (e.g., a maximum average thrust) of 0.209±0.049 N using, for example, eight, inline Pt-CNT-MMs exposed to 50% w/w H₂O₂ in a manually driven high burst flow. This generated thrust falls within the milli-Newton thrust range typically required for MUV propulsion, while leaving the possibility for thrust generation improvement through the inclusion of additional Pt-CNT-MMs in the reaction chamber. Accordingly, the vehicle 100 can be a union of CNT-templated microfabricated structures with electroless chemical deposition of catalytic Pt nanoparticles for thrust generation by the decomposition of H₂O₂ for MUVs.

At least some aspects of the propulsion device 110 can be fabricated using CNT-templated microfabrication. Aspects of the microfabrication process are illustrated in at least FIGS. 3A through 3F.

The microfabrication process can include exploiting lithographically defined metal (e.g., iron (Fe)) catalyst regions, whereon vertically aligned CNT forests can be, for example, grown in a quartz tube furnace with, for example, ethylene gas (C₂H₄ at 750° C.) acting as the carbon feedstock gas (shown in at least FIGS. 3A through 3D). By a similar chemical vapor deposition (CVD) process, for example, performed at an elevated temperature (900° C.), these CNT forests can be infiltrated with a mixture of graphitic and amorphous carbon (or other materials) to coat the outer walls of the CNTs (shown in FIG. 3E). In some cases, all (or substantially all) void space between CNTs can be filled with a desired material, thereby forming solid walls patterned according to the existing CNT layout during growth. The variable porosity of the CNT structures is controlled in part by the exposure time of these structures to the infiltration process.

FIG. 3F illustrates a representative carbon-infiltrated CNT-MM (CNT is herein taken to mean carbon-infiltrated CNT) with low-porosity sidewall surfaces. The precise patterning capabilities of photolithography and the macro-scale growth size of CNTs, in conjunction with the added structural versatility afforded by CNT-templated microfabrication, allows for the creation of a variety of high aspect ratio, nanocomposite materials of varying porosity/composition with enhanced structural integrity.

In summary, FIG. 3A illustrates photoresist being patterned onto a silicon (Si) wafer coated with alumina (Al₂O₃). FIG. 3B illustrates thermal evaporation of iron (Fe) for CNT growth. FIG. 3C illustrates a resultant Fe pattern after solvent lift-off process to obtain hydraulic diameters of a few microns (e.g., 4.025 μm). FIG. 3D illustrates CVD growth of high-aspect ratio CNT-MMs (e.g., ˜600 μm height) with an ethylene gas mixture as the carbon feedstock gas. FIG. 3E illustrates carbon-infiltration of CNT-MM. FIG. 3F illustrates an SEM image of resultant CNT-MM structure. Although a particular process is described, in some implementations, the reactants, process steps, and/or so forth can be modified.

In some implementations, the CNT-MMs included in the propulsion device 110 can be patterned using a close-packed, diamond-shaped channel mask. In some implementations, the CNT-MMs can have a different profile shape or pattern (e.g., a circular pattern, a hexagonal pattern, a square or rectangular pattern, an irregular or regular pattern of different shapes or profiles) (when viewed along a direction of the microchannels). In some implementations, a hydraulic diameter of greater than a few microns, or less than a few microns can be defined within the CNT-MMs. In some implementations, CNT-MMs with a wall thickness (e.g., minimum wall thickness) of a few microns or less can be defined (e.g., ˜2.0 μm). In some implementations, additional CNT-templated microfabrication parameters can be used to define CNT-MMs with a variety of dimensions (e.g., approximately 600 μm thick with channel aspect ratios of 150:1).

In some implementations, reactive ion etching (ME) can be used to remove the carbon floor layer formed at the base of the CNT-MM against the substrate during the CVD infiltration process. In some implementations, the ME process can also function to enhance subsequent metallic deposition, therefore, the face opposite the carbon floor layer can also be etched.

In some implementations, nanostructured morphologies of a catalyst (e.g., Pt catalyst) can be tuned and subsequently exploited to enhance electrocatalytic performance of the propulsion device 110. Specifically, needle-like or urchin-like structures display favorable electrocatalytic activity because of their large surface area and desirable geometry (corners, edges, etc.). As a specific example, this morphology is desirable for H₂O₂ decomposition, and can be achieved by chemically depositing Pt under conditions of relatively low solution pH (≦2.5) and relatively high Pt loading concentration (≧20% w/w Pt—C) resulting in growth of relatively dense Pt nanowires (approx. 10-30 nm in length and 3-4 nm in diameter) on non-porous, singular carbon spheres, carbon nanotubes, and cellulose paper as well as three-dimensional graphene.

Specifically, highly catalytic urchin-like Pt can be deposited as nanoparticles onto the CNT-MMs. In some implementations, the Pt can be deposited deep within the CNT microchannels. Electroless deposition can be performed on a per-mass basis and can involve CNT-MM submersion in a static solution of relatively low pH (<1.5) and high Pt molarity (H₂PtCl₆.(H₂O)₆ at ˜10 mM) for each deposition. Dense coverage of urchin-like Pt nanoparticles is produced as the reduction time of the Pt precursor is increased. This is realized when there is an abundance of H⁺ ions in solution (i.e., low pH). Given that no base additives may employed in some implementations, solution pH can be inversely related to Pt molarity. Thus, for a given volume of solution, the desired Pt nanoparticle morphology and density can be obtained by increasing the Pt—C loading of the solution (25-30% w/w Pt—C) and maintaining a low solution pH (<1.5).

FIG. 3G illustrates a CNT structure 300 with a high aspect ratio. As shown in FIG. 3G, the CNT structure 300 includes micro-channels 310 defining relatively long lumens compared with the widths of openings at the ends of the micro-channels 310.

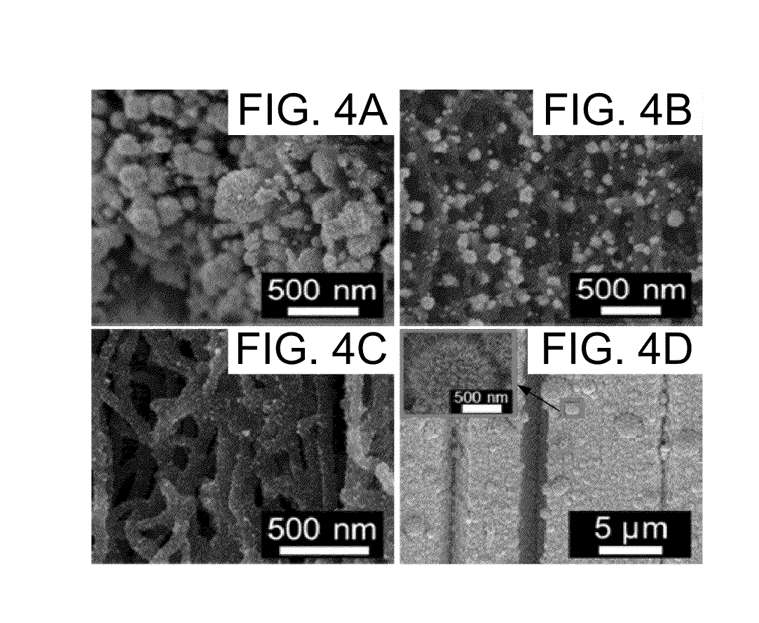

FIGS. 4A through 4D are images via SEM that illustrate resultant Pt nanoparticle morphology and density within Pt-CNT-MMs (which can be used in a propulsion device such as propulsion device 110 shown in FIG. 1). FIG. 4A illustrates that the entry region sidewalls of a Pt-CNT-MM are uniformly covered with dense urchin-like Pt clusters, a Pt morphology that resembles those produced in, for example, 60% w/w Pt—C solution and 2.5 pH loadings. Around these entry regions, Pt clusters are observed to protrude from the sidewall into the microchannel by as much as, for example, 400 nm. The apparent roughness that these clusters, and their urchin-like structure, add to the microchannels can facilitate additional fuel/catalyst interaction.

FIGS. 4B and 4C are images at successively longer distances (approximately 25 μm and 280 μm, respectively) into the CNT-MM microchannel. In some implementations, FIG. 4C can be an image at a center of a microchannel depth. FIGS. 4B and 4C reveal a uniform spread of Pt catalyst ranging in maximum centripetal protrusion lengths of approximately 120 nm and 13 nm, respectively. Hence, the size of urchin-like Pt nanowires near the midpoint of each microchannel can be considerably smaller than their entry-region counterparts. Nevertheless, evidence of Pt coverage in the axial center (e.g., center portion) of the channel indicates that static Pt deposition is indeed configured to reach even the most inward portions of the CNT microchannels. Furthermore, SEM imaging in FIG. 4D of a peripheral region of the Pt-CNT-MMs shows the high affinity of Pt precursor to the O₂ etched CNT-MM structure. Comparison of the lightly coated inner regions of the Pt-CNT-MM against the densely coated peripheral regions suggest that exposure to the bulk Pt solution enhances Pt coverage, and thus the deposition process is likely diffusion-limited near the axial center of the channel. In some implementations, improved coverage of the deposition process can be achieved in non-quiescent environments such as flowing deposition conditions. FIG. 4D is an image of total coverage along periphery of Pt-CNT-MM with inset showing the urchin-like morphology and arrangement of the deposited Pt. Although FIGS. 4A through 4D are focused on Pt catalysts, similar characteristics can be obtained for other types of catalysts.

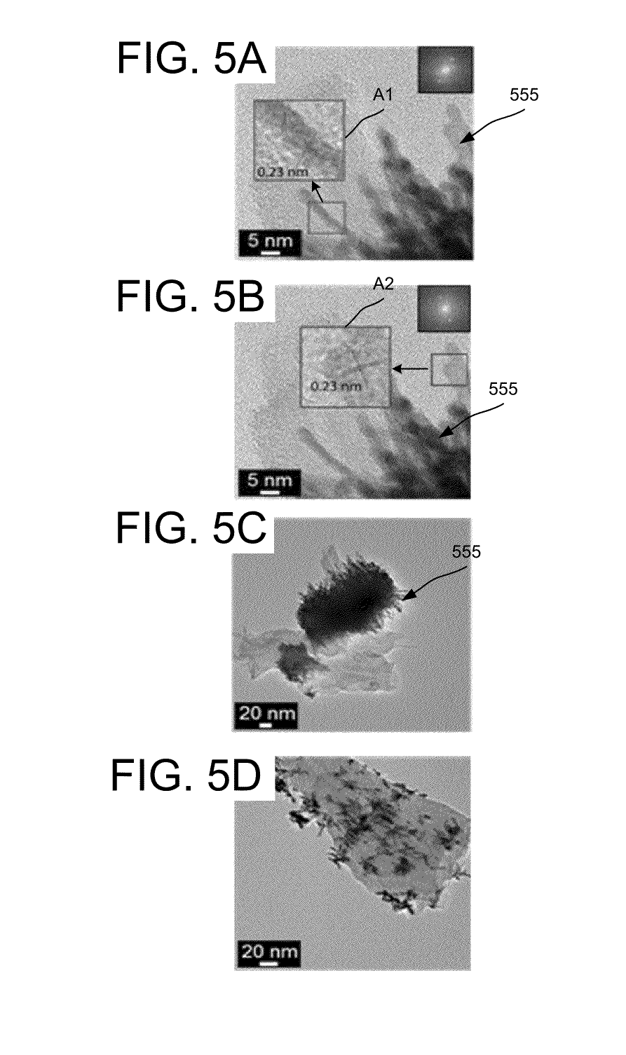

FIGS. 5A through 5D are high-resolution TEM images that illustrate the deposition of Pt nanoparticles onto CNTs (which can be used in a propulsion device such as propulsion device 110 shown in FIG. 1), as well as further characterization of the dimensions of the Pt nanowires 555. FIGS. 5A and 5B illustrate a d-spacing between (111) planes of 0.23 nm within the Pt-CNT-MM by TEM, confirming that the deposited nanoparticles are Pt. Specifically FIG. 5A illustrates a TEM image showing lattice spacing of a synthesized Pt nanowire 555 with Fast Fourier Transform (FFT) inset Al. FIG. 5B illustrates the same TEM image as in FIG. 5A showing the lattice spacing of the Pt nanowire 555 on the same cluster but having different crystal plane orientation with FFT inset A2. TEM analysis further confirms that the larger Pt urchins have nanowires 555 with lengths of up to 30 nm. Morphologies of this type, as illustrated in FIG. 5C, dominate the entry regions of the Pt-CNT-MM microchannels whereas smaller clusters, as illustrated in FIG. 5D, fill the central interior for deposition in quiescent conditions. It is also shown that urchin-like Pt nanowires 555 in the central interior are half this maximum length, or approximately 15 nm. Pt nanowire 555 diameters measured, however, can coincide with the 3 nm dimension typically observed here. While average Pt nanowire 555 dimensions (length and diameter) are consistent between clusters at comparable regions along (e.g., axially along) the Pt-CNT-MM channels, the orientation of their (111) planes can vary drastically, in some implementations, between nanowires 555, regardless of region and cluster. FIG. 5C illustrates a fragment having dense Pt cluster coverage and large growth size, similar to the entrance region of Pt-CNT-MM microchannels. FIG. 5D illustrates a fragment having less dense urchin-like Pt cluster coverage and smaller growth size, similar to the central interior of Pt-CNT-MM.

Due to their high surface energy and micro/nanoscale surface roughness, CNT structures that can be included in a propulsion device 110 such as shown in FIG. 1 can be natively hydrophobic. Introducing capillary action via hydrophilic enhancement of CNTs facilitates intimate contact between fuel (an aqueous reagent) and catalyst, thereby lending to improved fuel decomposition rates. In order to provide hydrophilic enhancement without jeopardizing the structural integrity of the Pt-CNT-MM, a controllable hydrophilic enhancement scheme can be included, suitable to CNT structures.

In some implementations, hydrophobic disposition of CNT substrates can be altered by ultraviolet assisted ozone treatment, ME, chemical oxidation and subsequent functionalization, chemical etching, and by patterning the CNTs to form hydrophobic topologies. In some implementations, O₂ ME can be used because it allows for a controllable means of modifying the CNT surfaces to be hydrophilic. Accordingly, in some implementations, each CNT-MM included in the propulsion device 110 can be exposed to a brief O₂ etch after growth to improve the penetration of aqueous solution into the CNT-MM pores during Pt deposition.

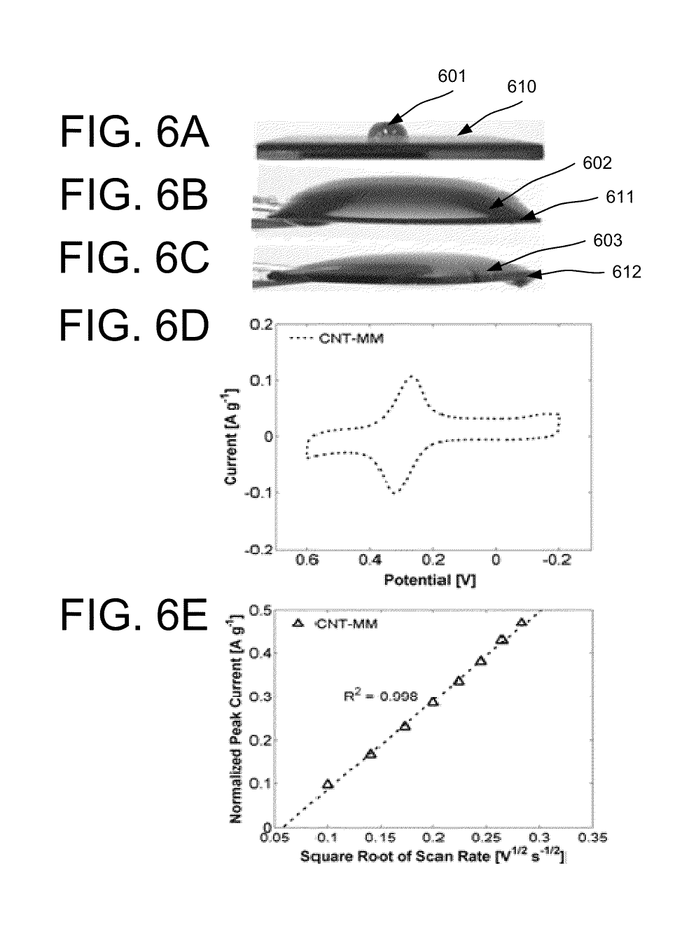

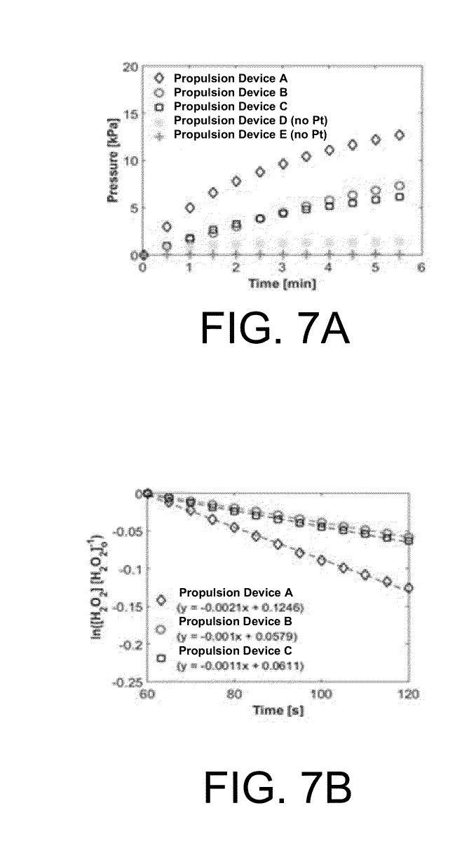

In some implementations, the hydrophobic nature of the CNT-MMs can be observed during each stage of the fabrication process. FIG. 6A through 6C illustrate images of ultrapure water droplet(s) on a CNT-MM at various stages of fabrication (all images taken at same magnification) according to an example implementation.

In some implementations, ultrapure water droplets (10 μL) can be dispersed onto separate regions across the surface of a CNT-MM propulsion device before O₂ etching. In some implementations, the water droplets may not appear to wet the CNT-MM channels at any appreciable rate indicating that the surface appeared to be hydrophobic as shown in FIG. 6A. This observation can be confirmed as the wetting angle of each droplet can be measured using, for example, a Ramé-Hart precision contact angle goniometer, and can be found to have an average value of 110.6±2.1°. This angle can be indicative of a hydrophobic surface, but is lower than the reported water contact angles for CNTs given in related studies. This discrepancy can be caused by the smooth graphitic/amorphous carbon coating on the outer walls and caps of the CNTs.

Specifically, FIG. 6A illustrates a water droplet 601 on a CNT-MM 610 (which can be used in, or as, a propulsion device) before O₂ RIE, showing hydrophobic nature of CNTs. FIG. 6B illustrates a water droplet 602 wicking through and dispensing on top of an O₂ RIE etched CNT-MM 611 (which can be used in, or as, a propulsion device), showing a hydrophilic nature. FIG. 6C illustrates a water droplet 603 wicking through and dispensing on top of a Pt-CNT-MM 612 (which can be used in, or as, a propulsion device), also exhibiting hydrophilic response.

FIG. 6D illustrates a current-voltage characterization of CNT-MM propulsion device within ferricyanide mediator solution (4 mM Fe(CN)₆³⁻ and 1 M KNO₃). Representative cyclic voltammogram (current normalized by propulsion device mass) for a CNT-MM propulsion device. FIG. 6D illustrates a plot of the magnitude of the normalized anodic peak current vs. the square root of the scan rate for a CNT-MM propulsion device, indicating that the transport of ferricyanide to the CNT-MM surface is a diffusion-controlled process.

In some implementations, post O₂ etched CNT-MM propulsion devices can have hydrophilic behavior as water can spread along the top surface of the membrane and then wick through to the bottom surface of the membrane as shown in FIG. 6B. Similar hydrophilic behavior can be exhibited by the Pt-CNT-MM as shown in FIG. 6C. In some implementations, if the channel sidewalls can be hydrophobic at these stages, aqueous solution would not fill a small channel of this diameter due to the inability to overcome the Laplace pressure. In some implementations, as a result of the spreading and capillary action, no contact angles are reported for either the O₂ etched CNT-MM propulsion devices or Pt-CNT-MM propulsion devices. In some implementations, these wetting observations support the additional characterization by electrochemical means (which are aqueous-based), as well as subsequent use in propulsion generation where aqueous-based fuel (i.e., H₂O₂) effectively penetrate the pores of the Pt-CNT-MM for catalysis.

In some implementations, current-voltage analysis can be employed to quantify the electroactive surface area for CNT-MMs fabricated under prescribed conditions. In some implementations, CV tests can be conducted for CNT-MM propulsion devices acting as the working electrode, a Ag/AgCl electrode acting as the reference electrode and a coiled Pt wire as the counter electrode. In some implementations, initial tests can be ere performed using a ferricyanide solution acting as mediator.

In some implementations, electroactive surface areas (EASAs) can be calculated using the Randles-Sevcik Equation (Equation 1), where iₚ is the peak redox current A, n is the number of electrons transferred per redox reaction, A is the EASA cm², D is the mediator diffusion coefficient (6.7×10⁻⁶ cm² s⁻¹ for a ferricyanide solution of 4 mM Fe(CN)₆³⁻ and 1 M KNO₃), c is the solution concentration mol cm⁻³, and v is the potential scan rate V s^{-1.6} CVs obtained with a potential scan that can be cycled between −0.2 and 0.6 V versus the Ag/AgCl reference electrode with a scan rate of 10 mV s⁻¹ (See FIG. 6D).

iₚ=2.686×10⁵n^{3/2}AcD^{1/2}v^{1/2} (1)

In some implementations, to allow for comparison between CNT-MMs of any dimension as well as account for variations in growth across the CNT-MM surface, CV data can be normalized according to propulsion device mass. Hence, EASA calculations can be used to determine the electroactive specific surface area (SSA, EASA per unit mass) for each propulsion device. In some implementations, CNT-MM can have an average SSA of 293±28 cm² g⁻¹.

In some implementations, a linear relationship can exist between the magnitude of the normalized anodic peak current and the square root of the scan rate for the CNT-MM propulsion device within the ferricyanide mediator solution as shown in

FIG. 6E. This linear correlation (R² values>0.99) suggests that the redox reaction of ferricyanide at the surface is a diffusion-controlled process for CV in a static environment.

CNT-MM propulsion devices can exhibit a type II nitrogen adsorption isotherm indicative of a macroporous material, with an average calculated BET surface area of, for example, 61 m² g⁻¹ and a pore volume of 0.118 cm³ g⁻¹. Table 1 shows the average calculated BET surface area for CNT-MM propulsion devices with comparison to similar structures. Most notably, the BET surface area for the CNT-MMs is approximately half that of pristine CNTs. This is likely attributable to the carbon-infiltration step of the CNT-MM fabrication process, which not only contributes additional mass throughout the structure, but may also cause a reduction in surface area by joining adjacent CNTs. However, the infiltration procedure allows for controllable porosity (mass/surface area) and improved structural integrity.

TABLE 1
Comparative BET surface area values.

| Structure | BET Surface Area (m² g⁻¹) |
|---|---|
| Pristine CNTs | 131 |
| Polycarbonate Monolith | 69 |
| CNT-MM | 61 |
| Polyacrylonitrile Membrane | 39 |
| Zirconia Microtube | 23 |

The effectiveness and durability of catalysts for H₂O₂ decomposition within the propulsion device 110, for example, can be dependent upon multiple factors including material composition, surface area, and reaction temperature. Namely, catalytic performance can be an ability to reduce the activation energy required for a given chemical reaction. A variety of catalysts can be used for lowering the activation energy associated with H₂O₂ decomposition including metal catalysts (e.g., Pt, Pd, Au and Ag) as well as metal oxide catalysts (e.g., MnO₂, Fe₂O₃, K₂Cr₂O₇). In some implementations, although highly effective at lowering the activation energy of H₂O₂ decomposition, metal oxide catalysts are consumed during H₂O₂ decomposition and therefore would not be able to provide recurring thrust for MUV propulsion. Accordingly, in some implementations, metal catalysts can be used in the propulsion device 110. In some implementations, the effectiveness of metal catalysts for H₂O₂ decomposition can be proportional to the exposed catalyst surface area. In some implementations, in the case of Pt catalysts, more exposed metal correlates to more free catalytic sites available for Pt—(OH) and Pt—(H) binding—two reactions that are involved in the eight kinetic steps in H₂O₂ decomposition with Pt metal catalysts. Furthermore, in some implementations, the reaction rate for the decomposition of H₂O₂ can tend to dramatically increase as the temperature of the exothermic reaction increases. In some implementations, this phenomenon can be due to the auto decomposition of H₂O₂ at elevated temperatures and to the fact that oxygen solubility remains low even at higher temperatures. Hence the reaction rates of H₂O₂ decomposition can tend to increase due to the conflation of both increased surface area and reaction temperature in some implementations.

In some implementations, transport processes may also alter the performance of the Pt-CNT-MM catalysts within the propulsion device 110, including the following: transport of reactants from the main fuel stream to the Pt-CNT-MM surface; transport of reactants within the CNT microchannels to the Pt metal surface; adsorption/desorption of reactants/products at the Pt metal surface; transport of desorbed products from the Pt metal through the CNT microchannels; and transport of desorbed products from within the CNT microchannels to the main stream of fluid. Consequently, the activation energy can change according to the rate of flow introduced into the reaction chamber. Therefore, an effective activation energy of the Pt-CNT-MM as measured within a convective fuel flow field can mimic, in part, the convective flow field that would be experienced in an actual MUV reaction chamber. In some implementations, the impact of convection on activation energy may not be considered and often the conditions of fluid stirring are not provided. In some implementations, the activation energy under flowing conditions can be equivalent to the effective activation energy, though specific to the conditions of the flow field.

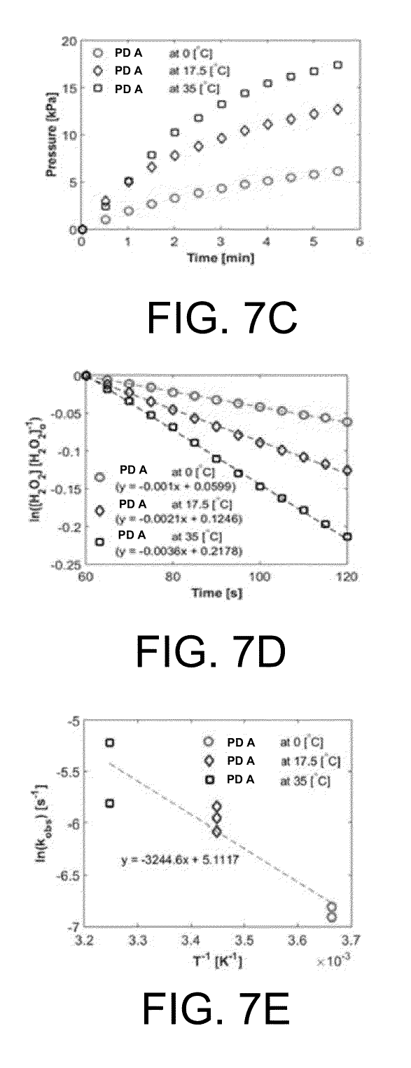

FIGS. 7A through 7E illustrate effective activation energy data for specific examples of CNT-MM and Pt-CNT-MM propulsion devices. FIG. 7A illustrates measured differential pressure versus time data taken as the average of two or more test runs per propulsion device at 17.5° C. for Pt-CNT-MM Propulsion devices (PD) A, B, and C, as well as for CNT-MM Propulsion devices D and E at 35° C.; data recorded at 1 Hz, sample data shown at 0.033 Hz. FIG. 7B illustrates reaction rate plots calculated according to Equation 3, using data from FIG. 7A and shown at 0.2 Hz. FIG. 7C illustrates measured differential pressure vs. time data taken as the average of two or more tests for Propulsion device A, performed at three temperatures (0° C., 17.5° C. and 35° C.); data recorded at 1 Hz, propulsion device data shown at 0.033 Hz. FIG. 7D illustrates reaction rate plots calculated according to Equation 3, using data from FIG. 7C and shown at 0.2 Hz. FIG. 7E illustrates plot of the natural log of the Arrhenius Equation for each test run of Propulsion device A with slope used to determine effective activation energy. Dashed lines represent linear curve fits of the data, with equations provided for FIGS. 7B, 7D, and 7E. Goodness of fit values for FIGS. 7B and 7D are R²>0.996 and for FIG. 7E is R²=0.867.

In some implementations, the effective activation energy (Eₐ) for H₂O₂ decomposition by the micro/nanostructured Pt-CNT-MMs can be empirically determined. In some implementations, H₂O₂ decomposition testing can be performed on replicate Pt-CNT-MM propulsion devices (referred to as Propulsion devices A, B, and C). Each propulsion device can be exposed to 1% w/w H₂O₂ solution at three different temperatures (0° C., 17.5° C. and 35° C.) in a test flask while the differential pressure, resulting from O₂ generation during decomposition of H₂O₂, can be monitored (Equation 2).

2H₂O₂→2H₂O(l)+O₂(g) (2)

The measured differential pressure generated by the reaction products (taken as the average of two or more test runs per propulsion device) can be plotted for comparison against two distinct control propulsion devices, both tested at 35° C. (shown in FIG. 7A). These control propulsion devices (referred to as ‘Propulsion devices D and E’) can be fabricated following the same procedure as for Propulsion devices A, B, and C, but received no Pt deposition. As shown, Propulsion devices A, B, and C generate significantly more pressure than Propulsion devices D and E, despite being tested at a lower (less favorable) temperature. Furthermore, negligible pressure rise can be observed for the uncoated propulsion devices, demonstrating that catalytic performance of Pt-CNT-MMs toward H₂O₂ is strongly dependent on the presence of Pt nano-urchins deposited onto the MWCNT microstructure.

Differential pressure data shown in FIG. 7A, for Propulsion devices A, B, and C, can be used in conjunction with the ideal gas law (PV=nRT), to determine the number of moles of O₂ released during the reaction (n), where P is the measured differential pressure kPa, V is the volume of the flask (125 mL) R is the ideal gas constant (8.314 J mol⁻¹ K⁻¹), and T is the bath temperature for the flasks K. Using this data, in accordance with stoichiometry associated with Equation 2, the quantity of H₂O₂ decomposed by the catalyst can be determined. The reaction rate constant for the decomposition of H₂O₂ can be determined by the following first-order reaction equation:

$$ln ( \frac{[ {H}_{2} {O}_{2} ]}{{[ {H}_{2} {O}_{2} ]}_{o}} ) = - {k}_{obs} t \qquad ( 3 )$$

where [H₂O₂] is the quantity of hydrogen peroxide remaining in solution at time t, [H₂O₂]ₒ is the initial quantity of H₂O₂ in solution, and k_{obs} is the reaction rate constant s⁻¹ over time.

FIG. 7B illustrates the ratio of the remaining fuel to the initial quantity of fuel (10 mL of 1% w/w H₂O₂ solution), used to determine the reaction rate constant for the data in FIG. 7A according to Equation 3. To avoid inclusion of initial noise in the pressure data, measurements taken between 60 and 120 s can be used for some (or all) calculations of k_{obs}. Additional testing of Propulsion device A under three different temperatures (0° C., 17.5° C. and 35° C.) illustrated higher observed decomposition rates with increasing temperature (as shown in FIGS. 7C and 7D).

The natural log of the Arrhenius Equation (Equation 4) with the calculated observed reaction rate constants are used to calculate the effective activation energy.

$$ln ( {k}_{obs} ) = - \frac{{E}_{a}}{R} \frac{1}{T} + ln ( A ) \qquad ( 4 )$$

Here, Eₐ is the effective activation energy of the catalyst J mol⁻¹, and A is the pre-exponential factor s⁻¹. By plotting the natural log of the observed reaction rate constant for each test run as a function of inverse temperature for Propulsion device A, the effective activation energy (26.96 kJ mol⁻¹) can be acquired from the slope of the linear fit of the data (shown in FIG. 7E). Error associated with the effective activation energy value is bounded by the upper and lower limits of 33.70 and 20.12 kJ mol⁻¹, respectively, calculated using slopes of the extreme cases presented in FIG. 7E).

Table 2, provides an overview of the calculated decomposition kinetics for a Pt-CNT-MM (Propulsion device A), including the entropy of activation, ΔS (J mol^{-1 1}; where ΔS=R·ln(A)). This effective activation energy of 26.96 kJ mol⁻¹ can improve upon similar nanostructured surfaces such as those comprised of graphene (28.8 kJ mol⁻¹) and Pt/palladium nanoparticles on Nafion (34.0-36.3 kJ mol⁻¹). Furthermore, the effective activation energy is lower than a Pt-paper catalyst (29.5 kJ mol⁻¹) where similar Pt nano-urchins can be deposited on cellulose sheets—such improvement can be due to the higher surface area achieved by the three dimensional architecture created by the CNT microchannels of the CNT-MM as opposed to the planar structure of the cellulose sheets.

TABLE 2
Average H₂O₂ decomposition kinetics for the Pt-CNT-MMs.
Range of possible values and one standard deviation
shown in parentheses for Eₐ and ΔS, respectively.

| Temper- | | | | |
|---|---|---|---|---|
| ature | k_{obs} | Eₐ | A | ΔS |
| [° C.] | [s⁻¹ × 10⁻³] | [kJ mol⁻¹] | [s⁻¹] | [J mol⁻¹ K⁻¹] |
| 0 | 1.0 ± 0.1 | 26.96 | 165.84 | 42.47 |
| 17.5 | 2.1 ± 0.3 | (33.70 < Eₐ < 20.12) | | (±34.36) |
| 35 | 3.6 ± 1.7 | | | |

FIGS. 8A through 8C illustrate aspects of an MUV submersible 800.

Specifically, FIG. 8A illustrates the MUV submersible assembly and water tank setup for monitoring thrust capability. FIG. 8A illustrates an optical image displaying the MUV submersible 800 components (in a disassembled state) with. The MUV submersible 800 includes a front nozzle 810 with a fuel receiver (e.g., H₂O₂ receiver) port 812 (which can be at the front or at other locations within the MUV submersible 800) and a torque arm adapter 814. The MUV submersible 800 includes a slotted propulsion device 820 (which can be configured to contain CNT structures) and an O-ring 830 for pressure seal between the front nozzle 810 and a rear nozzle 840. FIG. 8B illustrates the MUV submersible 800 in an assembled state. FIG. 8C illustrates the MUV submersible 800 (in an assembled form) and water tank setup.

The MUV submersible 800 illustrates the ability of Pt-CNT-MMs to produce thrust via H₂O₂ decomposition. The MUV submersible 800 can be fabricated via, for example, a 3D printer. As shown in FIG. 8A, the MUV submersible 800 is configured to house eight inline Pt-CNT-MM propulsion devices. In some implementations, the square planar surface area of the propulsion devices can be on the order of a few square centimeters (e.g., approximately 3 cm²). In some implementations, the square planar surface area of the propulsion devices can be less than a few square centimeters or greater than a few square centimeters. In some implementations, the MUV submersible 800 can be configured to house a different number of CNT structures that can be the same or different planar surface areas. Measurement of the propulsive thrust generated by the decomposition of H₂O₂ by Pt-CNT-MMs housed within the MUV submersible 800 can be performed by attaching a strain gauge to the mounting rod holding the test submersible. Syringe-fed tubing can be secured to the inlet port of the MUV submersible 800 for the supply of H₂O₂ fuel.

In some implementations, heterogeneous catalytic reactions can be heavily dependent on the mass transfer of reactant (fuel) to the catalytic surface. Thrust generated via decomposition of H₂O₂ fuel can therefore be dependent on the introduction rate of the fuel to the Pt-CNT-MM surface. This introduction rate can be modified in at least three ways—by changing the fuel concentration, changing the fuel flowrate, and/or by changing the available catalytic surface area. Accordingly, propulsion can be performed using a variety of H₂O₂ concentrations (e.g., 20, 35, and 50% w/w) at a variety of average flowrates (e.g., 10 mL s⁻¹) for a variety of combinations of CNT structures (e.g., one, two, four, six, or eight Pt-CNT-MMs). Also, propulsion can be manually driven flowrate (e.g., high burst flowrate) using a variety of conditions such as, for example, 50% w/w H₂O₂ for one, four, or eight Pt-CNT-MMs.

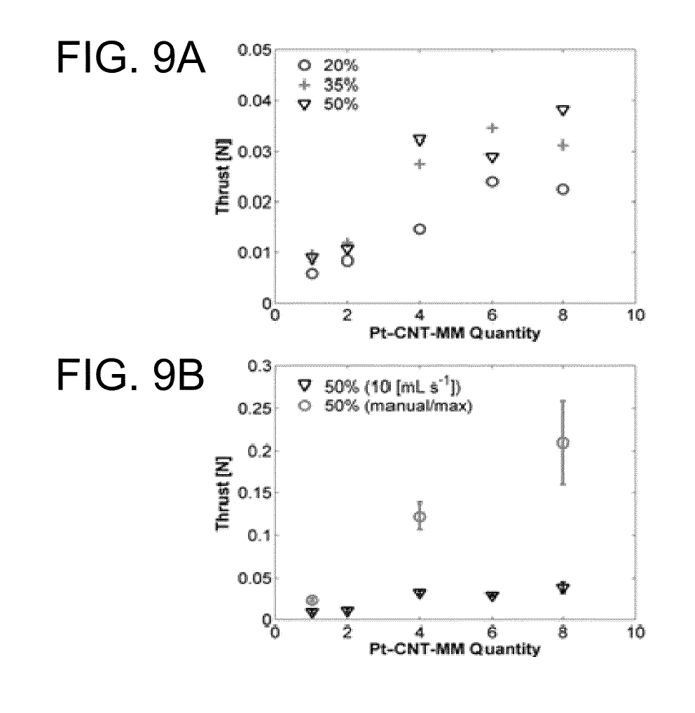

FIGS. 9A and 9B illustrate thrust measurement plots for H₂O₂ decomposition-driven propulsion (of a configuration of the MUV submersible 800 shown in FIGS. 8A through 8C. FIG. 9A illustrates varying H₂O₂ concentration (20, 35, and 50% w/w H₂O₂) per fixed flowrate (10 mL s⁻¹); 20 and 35% w/w H₂O₂ fuel approaching total decomposition with addition of Pt-CNT-MM propulsion devices. FIG. 9B illustrates fixed H₂O₂ fuel concentration (50% w/w H₂O₂) per varied flowrates (10 mL s⁻¹ and manually driven high burst flow); illustrates thrust generation dependence on H₂O₂ fuel flowrate.

In FIG. 9A, measured thrust under 10 mL s⁻¹ flow conditions is shown.

Comparison of corresponding 20 and 50% w/w H₂O₂ cases demonstrates that an increase in fuel concentration lends to greater generated thrust. Initially, with an increased quantity of Pt-CNT-MMs (increased catalytic surface area), there is a notable increase in measured thrust. For 20 and 35% w/w H₂O₂ runs, no appreciable thrust is observed by having greater than six Pt-CNT-MMs. This may be due to the H₂O₂ fuel approaching total decomposition within the reaction chamber of the MUV submersible 800 for these conditions.

Thrust produced at a fixed fuel concentration (50% w/w H₂O₂) for varying flowrates is presented in FIG. 9B. It is shown that both the 10 mL s⁻¹ and manually driven flowrates exhibit monotonically increasing thrust per additional Pt-CNT-MM, suggesting incomplete fuel decomposition. Higher thrusts can be attained by the addition of more inline Pt-CNT-MM propulsion devices until total fuel decomposition occurs. For a manually driven flowrate, a maximum thrust of 209±49 mN can be achieved using eight Pt-CNT-MMs, in this implementation. It is also observed that, for the same number of Pt-CNT-MM propulsion devices and H₂O₂ fuel concentration, the manually driven flowrate produces significantly greater thrust than that for 10 mL s⁻¹, suggesting a flowrate dependent thrust.

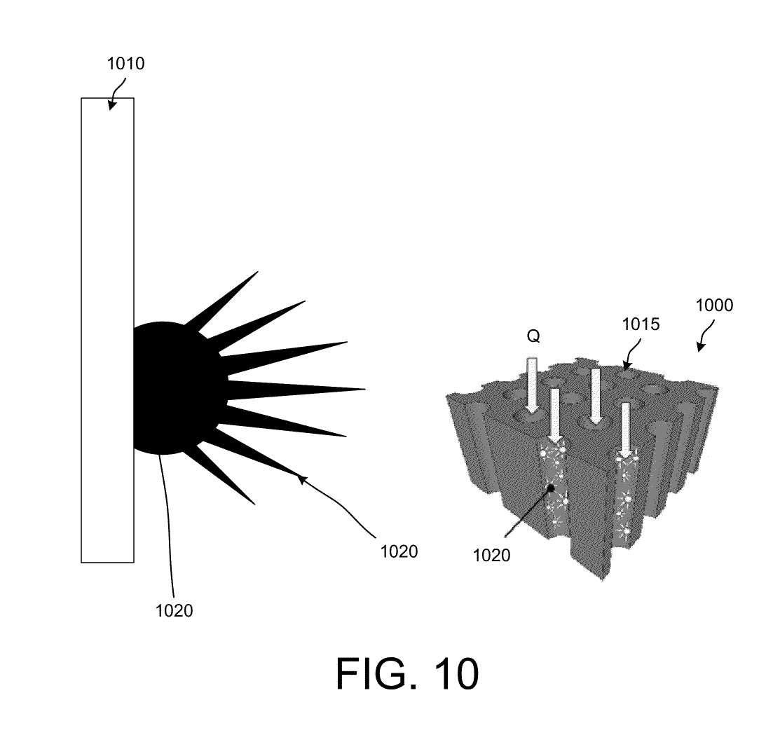

FIG. 10 is a diagram that illustrates operation of a propulsion device 1000. As shown in FIG. 10, the propulsion device 1000 has a channel wall 1010 of micro-channels 1015 and a catalyst 1020 (e.g., platinum) coupled to the channel wall 1010. A flow path Q through micro-channels 1015 is illustrated in response to a reaction with the catalyst 1020.

In some implementations, an increase in H₂O₂ fuel concentration, catalytic surface area, and flowrate can, alone, or in various combinations, contribute to additional thrust. In some implementations, thrust generated by catalysis can be dependent on the introduction rate of H₂O₂ fuel to the Pt-CNT-MM structure. In some implementations, the fuel can approach complete decomposition for a given fuel concentration and flowrate by addition of Pt-CNT-MMs.

As noted above, in some implementations, CNT-templated microfabrication techniques can be used to fabricate carbon-infiltrated multi-walled CNT scaffolds composed of highly ordered and aligned microchannels with desired geometry. Furthermore, urchin-like Pt nanoparticles can then be deposited onto, and throughout, the entirety of the CNT-MMs to provide a high aspect ratio catalytic microstructure for the enhanced propulsion of MUVs. In some implementations, Pt nanoparticle can be deposited onto carbon-infiltrated MWCNTs. In some implementations, a propulsion device (e.g., the propulsion device 110 shown in FIG. 1) can be produced using the union between CNT-templated microfabrication and chemical deposition of nanoparticles. Such an electroless deposition technique is capable of depositing nanoparticles ˜200 μm deep within the pores of the CNT microchannels.

In some implementations, post O₂ etched CNT-MM and Pt-CNT-MM propulsion devices can demonstrate hydrophilic behavior, which can be suited for aqueous-based characterization and propulsion methods and can be a significant shift from the hydrophobic nature of non-etched CNT-MMs. In some implementations, CNT-MM propulsion devices can achieve an average electroactive surface area of, for example, 293±28 cm² g⁻¹ (in some implementations, greater or lesser values can also be achieved) within a ferricyanide based CV solution. Additionally, effective activation energy testing of Pt-CNT-MM propulsion devices revealed a favorable performance of, for example, 26.96 kJ mol⁻¹ (in some implementations, greater or lesser values can also be achieved).

In some implementations, Pt-CNT-MMs as propulsion devices can be functionalized in 25-30% w/w Pt—C solution, for the propulsion of MUVs. In some implementations, multiple (e.g., 2, 4, 8, 10, 20) inline Pt-CNT-MMs included in a propulsion device can be exposed to manually driven high burst flows of 50% w/w H₂O₂, producing a maximum average thrust of, for example, 209±49 mN (in some implementations, greater or lesser values can be achieved). This propulsive bursting thrust can fall within the milli-newton thrust for MUV propulsion, and can be at least 6.5 times greater than that produced by biomimetic propulsion designs. The vehicles described herein minimize (or reduce) component exposure to the environment and includes a simple, static architecture relative to other micro-propulsion systems. Furthermore, additional thrust can be attained within the vehicles described herein by enhancing the introductory rate of the H₂O₂ fuel to the Pt-CNT-MMs, which would effectively increase the locomotive capability of this propulsion system.

As discussed above, a propulsion device can be formed using CNT-MM Fabrication. In some implementations, a silicon wafer can be coated with a relatively thin aluminum oxide film (Al₂O₃, >30 nm) using e-beam evaporation primarily to act as a barrier to subsequent reactions between the iron layer and the underlying silicon substrate. In some implementations, AZ nLOF2020 photoresist can be applied (e.g., can be spun on at 2750 rpm for 60 seconds) and soft baked (e.g., soft baked at 110° C. for 60 seconds). In some implementations, CNT-MM pore geometry and dimensions (diamond shape with nominal diagonal dimensions (e.g., dimensions of 4.5×9.0 μm) can be defined on the wafer by photolithography, and hard baked (e.g., hard baked at 110° C. for 60 seconds). In some implementations, the photoresist can be developed (e.g., developed in a lightly agitated, AZ300MIF solution). In some implementations, a relatively thin iron film (Fe, ˜7 nm) can be thermally evaporated onto the wafer surface as a catalyst for CNT growth. In some implementations, the wafer can be sonicated in solvent (e.g., insolvent for >10 minutes), rinsed (e.g., with Isopropyl Alcohol (IPA)), and dried (e.g., with compressed air to remove the entire photoresist layer and portions of the Fe layer in a lift-off process). In some implementations, to protect the wafer during propulsion device dicing, a relatively thin photoresist layer (e.g., AZ 3330) can be applied to (e.g., can be spun on) the wafer and soft baked. In some implementations, propulsion devices can be diced into (e.g., diced into 16.93×16.93 mm) squares or other shapes using a dicing saw. In some implementations, preparatory to CNT growth, diced propulsion devices with patterned Fe can be solvent cleaned to remove the protective photoresist layer.

In some implementations, CNT-MMA propulsion devices can be grown, released, and cleaned. After a quality inspection check with an optical microscope, diced propulsion devices can be placed on a quartz boat (e.g., in a Lindberg/Blue M Tube Furnace) for CNT growth. In some in some implementations, CNTs can be grown (e.g., for 26 minutes in flowing hydrogen (H₂, ˜216 sccm) and ethylene (C₂H₄, ˜280 sccm) at 750° C.). In some implementations, this can result in a relatively substantial height of the CNT-MM (e.g., height of approximately 600 μm). In some implementations, CNT-MMs can then be coated with carbon in a subsequent infiltration step (e.g., at 900° C. for 20 minutes) with similar gases and flowrates as those used during CNT growth (H₂ at ˜200 sccm and C₂H₄ at ˜280 sccm). In some implementations, this can result in carbon-infiltrated CNTs with diameters of a lesser measurement than the height (e.g., approximately 290 nm). In some implementations, during carbon infiltration, the CNT-MM structure can self-release from the wafer substrate. In some implementations, CNT-MMs can be exposed to a brief (e.g., 7 minute O₂) plasma etching (e.g., at 300 W using an Anelva Reactive Ion Etcher (ME), DEM-451) to remove the carbon floor (additional carbon blocking the base of the CNT-MM channels) and enhance hydrophilicity to improve subsequent deposition of Pt catalyst (e.g., 5 minutes for removal of the carbon floor layer; 2 minutes for opposite face).

In some implementations, urchin-like Pt nanoparticle can be deposited within a propulsion device (e.g., propulsion device 110 shown in FIG. 1). Deposition of Pt onto a CNT-MM propulsion device can be performed on a per-mass basis to maintain, for example, a 25-30% w/w Pt—C solution loading. In some implementations, for a CNT-MM with a mass of, for example, 0.1071 g, 122.8 mg chloroplatinic acid hexahydrate can be weighed out (37.5% Pt, Sigma Aldrich 206083) and mixed with, for example, 2.0 mL formic acid (88% HCOOH, Macron 2592-05) and 18.0 mL ultrapure H₂O. These chemicals can be added to a beaker (e.g., 50 mL glass beaker (VWR, 89000-198)) whereupon their pH levels can be measured. In some implementations, the pH for this deposition can be acidic (e.g., 1.16), enabling urchin-like nanoparticle growth. In some implementations, using a slotted ring (e.g., a Teflon ring) for a propulsion device stand, the CNT-MM can be positioned vertically in a plating solution. In some implementations, keeping the propulsion device oriented in this manner can ensure that the Pt nanoparticles may nucleate and grow on the carbon substrate rather than precipitating out of solution and simply collecting on the propulsion device face. As a specific example of an implementation, a mass of a CNT-MM that is 0.1071 g, the solution molarity (11.80 mM) can correspond to a 30.07% w/w Pt—C loading. In some implementations, the beaker can be covered by material until the deposition process is completed, as indicated by a solution color change from amber to clear. Upon removal from the beaker, and prior to subsequent testing, a propulsion device can be submerged in deionized water (e.g., for at least 5 minutes) and then placed in a dehydration bake (e.g., an Ultra-Clean 100 (3497M-3) dehydration bake oven for a minimum of 8 minutes).

In some implementations, electrodes can be attached for cyclic voltammetry testing of a propulsion device. In some implementations, a silver epoxy can be used to attach Nichrome wire to each propulsion device used for CV testing. After the silver epoxy is cured (e.g., approximately 24 hrs), a chemically inert lacquer coating can be applied to the silver joint. In some implementations, CV tests can be conducted using a three-electrode cell with the CNT-MM propulsion devices acting as the working electrode, a Ag/AgCl electrode acting as the reference electrode and a coiled Pt wire as the counter electrode. In some implementations, tests can be performed using a ferricyanide solution acting as mediator. In some implementations, multiple cycles (e.g., 3 cycles, 5 cycles, 10 cycles, 100 cycles) can be run per propulsion device test through a potential range (e.g., of −0.2-0.6 V) at a scan rate (e.g., of 10 mV s⁻¹). In some implementations, the peak redox current for each propulsion device can be taken as the average of both anodic/cathodic peak currents of the latter two CV cycles. In some implementations, runs can be performed at room temperature.

In some implementations, nitrogen gas adsorption testing of a propulsion device can be performed. In some implementations, Nitrogen adsorption analysis can be performed at a temperature such as 77 K. In some implementations, portion devices can be degassed (e.g., at 100° C.) prior to analysis. In some implementations, surface area can be calculated by the Brunauer-Emmett-Telller (BET) method, pore size can be measured by the Barrett-Joyner-Halenda (BJH) method using the adsorption branch of the isotherm, and total pore volume can be determined by the single point method at relative pressure (P/PO) 0.97.

In some implementations, effective activation energy tests, by H₂O₂ decomposition, can be conducted using Pt-CNT-MM propulsion devices fabricated following one or more of the procedures described above. Each propulsion device can be tested two or more times, after which the pressure data can be averaged per propulsion device. The test apparatus can include flasks (e.g., two, 125 mL, round-bottom flasks). In some implementations, one flask can be used for the Pt-CNT-MM test environment and the other as a reference environment. In some implementations, magnetic stir bars can be placed inside each flask and rotated (e.g., at 250 rpm) to increase the amount of H₂O₂ contacting the catalytic Pt-CNT-MM propulsion devices and mimic, in part, the convective flow environment experienced through injection of H₂O₂ fuel into a MUV. In some implementations, to ensure the flasks are airtight, rubber septums with a rim seal can be positioned on each flask. In some implementations, the flasks can be placed inside ice or water baths on top of a hot plate stirrer to maintain isothermal conditions during each of the two or more runs per propulsion device (0° C., 17.5° C. and 35° C.). In some implementations, to ensure that steam may not be produced during testing, such that all generated pressure can be due to the release of O₂, a relatively low concentration H₂O₂ solution (1% w/w H₂O₂, diluted from 30% w/w H₂O₂) can be used for all tests. In some implementations, the H₂O₂ solution stock can be placed within a container (e.g., a 50 mL container) and immersed in the respective ice/water baths in order to achieve thermal equilibrium prior to testing. After achieving thermal equilibration, each flask can be vented by temporary insertion of an unattached needle and allowed to equilibrate with atmospheric pressure. In some implementations, the amount of O₂ generated during each test can be measured as a pressure differential between the testing and reference environments. In some implementations, to measure the pressure differential, an differential pressure manometer (e.g., measuring up to ±5 psi/34.5 kPa) can be connected to each flask via two high strength silicone tubes (e.g., diameter 0.375 in/9.525 mm). In some implementations, the tubing can be connected to the manometer and syringe needles using barbed fittings. In some implementations, the two syringe needles connected to the pressure manometer can be inserted into the test and control flasks, respectively, by piercing through the diaphragm of each septa. In some implementations, the differential pressure between the test and control flasks can be zeroed before recording data and then measured as a function of time with a computer via a connection (e.g., a universal serial bus (USB) connection). In some implementations, H₂O₂ solution (e.g., 10 mL of the H₂O₂ solution) can be simultaneously injected into each flask while a stir bar (e.g., the magnetic stir bars) stirred the solution (e.g., at 200 rpm). In some implementations, resultant differential pressure vs. time data can be used to determine catalyst performance and effective activation energy with the Arrhenius Equation.

In some implementations, an MUV test submersible can be configured with computer aided design software and printed with a 3D printer, for example, with a PMMA like resin. The test submersible can be fitted to a rigid arm (e.g., a 30.5 in. (0.77 m) rigid arm through screw thread fastening and submerged into a water tank (350 gal)). In some implementations, the opposite end of the arm can be secured to a torque transducer (Interface model 5350-50:50 oz-in sensor) mounted above the water tank. The transducer can be used to measure torque measurements with 0.001 N-m precision along the parallel axis of the test submersible via a CPU connection. Force (thrust) measurements can be calculated via software on the CPU. H₂O₂ can be pumped into a reaction chamber via a 50 mL syringe connected to the test submersible's reaction chamber via high strength silicone tube (dia.: 0.375 in./9.525 mm) that fits over, for example, a plastic barbed fitting.

It will also be understood that when an element, such as a layer, a region, or a substrate, is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An apparatus, comprising:
a controller;
a fuel container; and
a propulsion device including a carbon nanotube structure including a parallel array of micro-channels configured to receive the fuel, each of the micro-channels included in the array of micro-channels having a length:width aspect ratio greater than 40:1 and including a catalyst.

2. The apparatus of claim 1, wherein the catalyst has a shape including an inner mass and protrusions protruding from the inner mass.

3. The apparatus of claim 1, wherein the catalyst includes a platinum catalyst.

4. The apparatus of claim 1, wherein the fuel container is configured to contain hydrogen peroxide.

5. The apparatus of claim 1, wherein the propulsion includes a carbon nanotube structure disposed between a second carbon nanotube structure and a third carbon nanotube structure.

6. The apparatus of claim 1, wherein the carbon nanotube structure is included in a plurality of carbon nanotube structures aligned in series.

7. The apparatus of claim 1, wherein the carbon nanotube structure is included in a plurality of carbon nanotube structure that are each vertically aligned.

8. The apparatus of claim 1, wherein each of the micro-channels included in the array of micro-channels has a length:width aspect ratio greater than 40:1.

9. The apparatus of claim 1, further comprising:
a control mechanism configured to control a direction of the apparatus via thrust produced by the propulsion device.

10. A method, comprising:
defining a propulsion device including carbon nanotubes having a plurality of micro-channels included in an array of micro-channels having a length:width aspect ratio greater than 40:1; and
depositing a catalyst in an interior portion of each of the micro-channels of the carbon nanotubes.

11. The method of claim 10, wherein the carbon nanotubes are grown in flowing hydrogen and ethylene.

12. The method of claim 10, wherein the catalyst is platinum.

13. The method of claim 10, wherein the array of micro-channels defines a first array of micro-channels of the propulsion device,
the method further comprising:
defining a second array of micro-channels in-line within the first array of micro-channels of the propulsion device.

14. An apparatus, comprising:
a controller;
a fuel container; and
a propulsion device including a first array of micro-channels of a carbon nanotube structure and a second array of micro-channels of a carbon nanotube structure, the micro-channels of the first array of micro-channels being axially aligned with the micro-channels of the second array of micro-channels.

15. The apparatus of claim 14, further comprising:
a catalyst disposed within the micro-channels of the first array of micro-channels.

16. The apparatus of claim 14, wherein each of the micro-channels included in the first array of micro-channels having a length:width aspect ratio greater than 40:1.
